(19) United States
(12) Patent Application Publication
(10) Pub. No.: US 2023/0409413 A1
(43) Pub. Date: Dec. 21, 2023

(54) Optimizing Screen Time Based On Situational Context

(71) Applicant: Koa Health B.V., Barcelona (ES)

(72) Inventors: Teodora Sandra Buda, Barcelona (ES); Roger Garriga Callega, Barcelona (ES); Aleksandar Matic, Lloret de Mar (ES)

(21) Appl. No.: 17/880,453

(22) Filed: Aug. 3, 2022

(30) Foreign Application Priority Data
Jun. 20, 2022 (EP) 22179789.7

(51) Int. Cl. G06F 9/54; G06F 11/34

(52) U.S. Cl. CPC G06F 9/542; G06F 11/3438

(57) ABSTRACT

A method for optimizing screen time for the user of a smartphone involves determines a target level of usage based on situational context. A period of time during which the user interacts with the smartphone is detected. A first operational mode is detected in which the user interacts with the smartphone during the period of time. A first situational context is identified in which the user is interacting with the smartphone. An interaction benefit to the user is determined based on the period of time, the first operational mode and the situational context. Whether the interaction benefit equals or exceeds the target level is determined. If the interaction benefit does not equal or exceed the target level, it is recommended that the user interact with the smartphone in a second operational mode or restrict the amount of time during which the user engages in the first operational mode.

### CROSS REFERENCE TO RELATED APPLICATION

This application is based on and hereby claims the benefit under 35 U.S.C. § 119 from European Patent Application No. EP 22179789.7, filed on Jun. 20, 2022, in the European Patent Office. This application is a continuation-in-part of European Patent Application No. EP 22179789.7, the contents of which are incorporated herein by reference.

### TECHNICAL FIELD

The present invention relates to a personalized and context-based recommendation engine for optimizing a user's screen time with an electronic device.

### BACKGROUND

Smart devices are tightly embedded in our everyday life, and an ample interest in the effects of their use both by the scientific community and the media does not come as a surprise. Previous work has highlighted the negative effects of smartphone usage and general screen time both in the context of typical as well as of atypical (usually referred to as excessive or problematic) use. Recently, however, researchers argue that there is a lack of strong evidence on the detrimental effects of smartphone use on mental health and that previous studies and systematic reviews overestimated the negative associations. It has even been found that the moderate use of digital technology is not intrinsically harmful and may be advantageous in a connected world.

Thus, it appears that the effects of smart device usage are more variable than expected and most likely vary with context. For example, using a smart device alone at home to consume social media may have a negative effect on the user, whereas using the smart device to play music when meeting with friends may actually have a positive effect on the user.

Furthermore, a problem associated with many smart devices is their limited battery life, as only a finite amount of energy can be stored in the device between battery loading times. Energy-intensive uses of a smart device may lead to an even faster decrease in battery level.

There thus exists a need for reducing the negative impact of smart device usage and/or increasing battery life of smart devices.

### SUMMARY

A method for adapting or optimizing the operation of an electronic device achieves a desired target level, for example an extended battery life or a higher wellbeing score of the user, by recommending the operational mode through which the user interacts with the electronic device or recommending that the user restrict the amount of time during which the user engages in the operational mode. The period of time during which the user interacts with the electronic device, such as a smartphone, is detected. A first operational mode in which the user interacts with the smartphone during the period of time is detected. A first situational context in which the user is interacting with the smartphone is identified. An interaction benefit based on the period of time, the first operational mode and the situational context is determined. Whether the interaction benefit equals or exceeds a target level is determined. For example, the target level is a desired battery level, a desired device utilization level, or a mental health wellbeing level. If the interaction benefit does not equal or exceed the target level, it is recommended that the user interact with the smartphone in a second operational mode or that the user restrict the amount of time during which the user engages in the first operational mode. Alternatively, if the interaction benefit does not equal or exceed the target level, notifications from the smartphone relating to the first operational mode are suppressed.

In one implementation, the interaction benefit is determined as a function of the period of time, and the first operational mode and the situational context are constant in the function. Based on the function, the maximum amount of time during which the user can engage in the first operational mode and maintain the interaction benefit at or above the target level is determined. In another implementation, a plurality of operational modes are ranked according to a maximum amount of time during which the user can engage in each operational mode and still maintain the interaction benefit above or at the target level. It is then recommended that the user interact with the smartphone in the second operational mode based on the second operational mode having a highest ranking.

A system for optimizing the operation of an electronic device achieves a desired target level, for example a higher wellbeing score of the user or an extended battery life, by recommending the operational mode through which the user interacts with the electronic device or recommending that the user restrict the amount of time during which the user engages in the operational mode. The system includes a timer, a mode detector, a sensor, an evaluation unit and a screen of a smartphone. The timer detects a period of time during which the user of the system interacts with the smartphone. The mode detector identifies a first operational mode in which the user interacts with the smartphone during the period of time. The sensor is adapted to identify a situational context in which the user is interacting with the smartphone. The evaluation unit is adapted to determine an interaction benefit based on the period of time, the first operational mode and the situational context. The evaluation unit then determines whether the interaction benefit equals or exceeds a target level. A corrective recommendation is displayed to the user on the screen of the smartphone if the evaluation unit determines that the interaction benefit does not equal or exceed the target level.

In one implementation, the recommendation is that the user should switch from interacting with the smartphone in the first operational mode to interacting with the smartphone in a second operational mode. Alternatively, the recommendation is that the user should limit an amount of time during which the user interacts with the smartphone in the first operational mode. The system can also suppress notifications to the user from the first operational mode if the evaluation unit determines that the interaction benefit does not equal or exceed the target level.

In another embodiment, a method for optimizing how a smartphone is used involves determining personal characteristics applicable to the user of the smartphone. Sensing data corresponding to how the user is interacting with the smartphone is detected. A situational parameter corresponding to a context in which the user is interacting with the smartphone is detected. An operational mode in which the user is interacting with the smartphone is detected. Based on the personal characteristics, the sensing data and the situational parameter, a maximum amount of time is determined during which the user can interact with the smartphone in the operational mode and still maintain a target wellbeing level. In one implementation, the target wellbeing level is a desired level of mental health to be achieved by a cognitive behavioral therapy. A period of time during which the user is interacting with the smartphone in the operational mode is detected. It is recommended that the user interact with the smartphone in a second operational mode if the period of time exceeds the maximum amount of time. Alternatively, it is recommended that the user stops engaging in the operational mode if the period of time exceeds the maximum amount of time.

Other embodiments and advantages are described in the detailed description below. This summary does not purport to define the invention. The invention is defined by the claims.

### BRIEF DESCRIPTION OF THE DRAWING

The accompanying drawings, where like numerals indicate like components, illustrate embodiments of the invention.

FIG. 1 illustrates the general concept of the context-dependent impact of screen time on a target state.

FIG. 2 illustrates an embodiment of the present invention.

FIG. 3 shows an exemplary function for inferring a state value.

FIG. 4 shows exemplary functions for inferring a state value for different operational modes of the device.

FIG. 5 is a table of sample situational parameters that pertain to a given context.

### DETAILED DESCRIPTION

Reference will now be made in detail to some embodiments of the invention, examples of which are illustrated in the accompanying drawings.

The present invention involves a computer-implemented method and a device for adapting or optimizing the operation of an electronic device to achieve a desired target state, for example extended battery life.

Additionally, a higher wellbeing score of the user by optimizing screen time may be achieved. The invention thus relates to a computer-implemented method for adapting the operation of a device to achieve a desired target state, comprising:

detecting the length of time during which a user interacts with the device, in particular screen time;

detecting a first operational mode of the device in which the device is operated during the time the user interacts with the device;

detecting at least one situational parameter of the user;

inferring a state value of the user and/or device based on the monitored time length and the detected operational mode of the device and the situational parameter of the user;

comparing the inferred state value of the user and/or device to a target state and evaluating whether the state value matches the target state or falls into a tolerance range surrounding the target state; and

if the evaluation result indicates that the state value does not match the target state or does not fall into the tolerance range surrounding the target state, taking at least one action relating to the operation of the device.

The state value of the user and/or device may also be directly measured, e.g., the heart rate of the user or a battery fill level of the device. In general, the target state may pertain to a state of the user and/or a state of the device, and the measured or inferred data or state values may similarly pertain to the user or device.

For example, it may be detected that the user interacts with the device for twenty min and that the device is operated during this time to display videos on a social media platform. At least one situational parameter of the user is detected, such as the location of the user, to determine that the user is present at home, for example.

Based on this detected information, preferably a model is used to infer by means of a function, a state value of the user and/or device. Based on historical data pertaining to the user, it may be inferred that previously when the user watched videos on a social media platform alone at home, a negative impact on the user's well being was detected, for example by sensing physiological data of the user or by the user actively reporting negative feedback to the device. For example, the user may be inferred to have a state value corresponding to a wellbeing score of 4.

Similarly, it may be detected that the displaying of videos rapidly drains battery life of the smart device and that the device has a state value corresponding to a battery fill level of 28%.

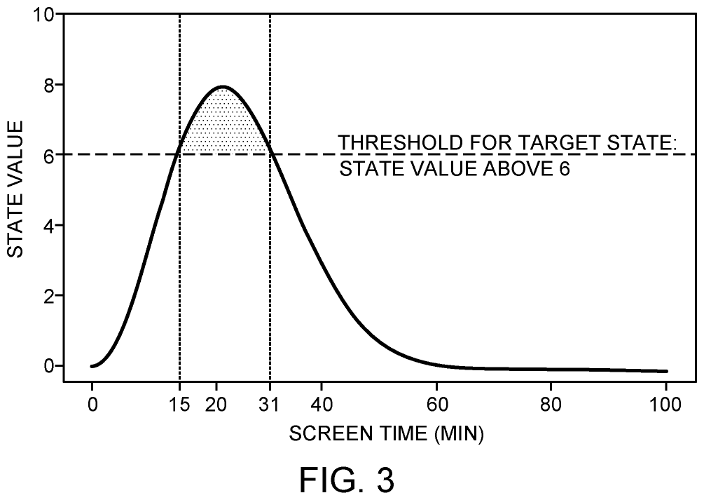

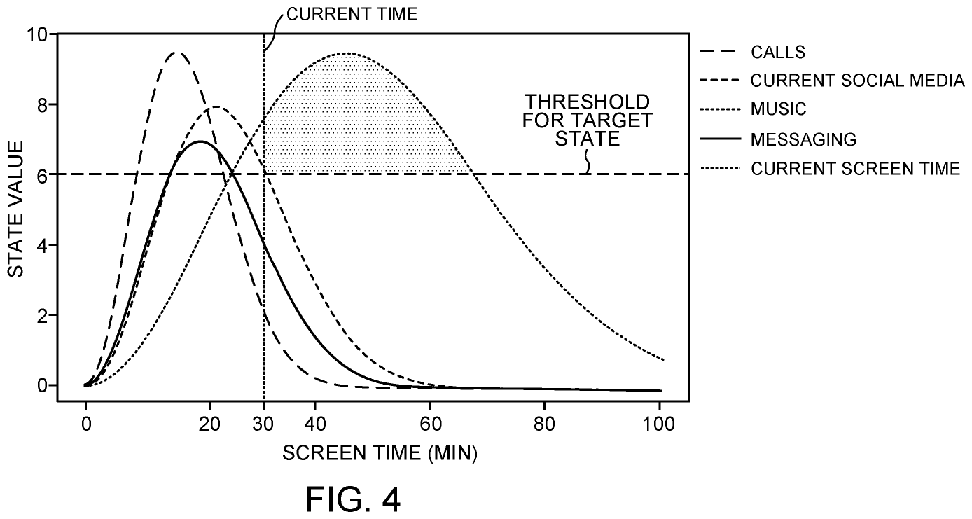

The function can be the following function Formula 1 displayed in the general format below. Examples of functions of this format are shown in FIG. 3 and FIG. 4 for illustration. Given the personal characteristics (P), passive sensing data (S), context/situational parameter(s) (C), screen time (t) and mode of operation (also referred to as purpose of use or purpose) (U)

$$f ( P , S , C , t , U ) = \frac{b ( P , S , C , U ) {t}^{2}}{a ( P , S , C , U \text{?}} {e}^{( \frac{{t}^{2}}{2 a ( P , S , C , U )} )} \qquad ( Formula 1 )$$

$$\text{?} \text{indicates text missing or illegible when filed}$$

where b(P,S,C,U) and a(P,S,C,U) are linear functions of each of the parameters, and the function f(P,S,C,t,U) is preferably optimized by minimizing the Mean Squared Error between f(P,S,C,t,U) and the actual state values observed on historical data.

A system or method according to the invention uses the function, in particular the function according to Formula 1, to infer the context (e.g., with family in the park, eating) that the user is experiencing, in particular to infer at least one situational parameter of the user, and/or to infer a current state value of the user and/or device.

The function takes into account a weighted sum of the data reflecting personal characteristics (P), passive sensing data (S), context/situational parameter(s) (C), screen time (t) and mode of operation (U). For example, the term a(P,S,C,U) of the function may take the form

a (P, S, C, U)=w₀+w₁gender+w₂age+w₃steps+w₄location_park+w₅location_home+w₆activity_eating+w₇activity_working+w₈company_friends+w₉company_family+w₁₀company_alone+w₁₁purpose_socialmedia+w₁₂purpose_music+w₁₃purpose_messaging,

wherein the numerical value of the weighting factors w0 to w13 preferably is set by the method or system based on historical data of a given user. Weighting factors are preferably generated for the term b(P,S,C,U) analogously. Weighting factors may vary between a(P,S,C,U) and b(P,S,C,U).

In other words, the system can be configured to generate a set of weighting factors associated with the at least one situational parameter of the user and/or at least one operational mode of the device, based on historical data relating to that user and/or device. If no such historical data are available for a given user, the device can retrieve historical data from similar people.

For example, historical data of a user may indicate that in the past, displaying videos for thirty minutes at lunch time resulted in the target state of a battery fill level of 25% at 6 pm not being reached by the user. Thus, the mode of operation “displaying videos” may be associated with a negative weighting factor because this mode of operation has shown to have a negative effect on the achievement of the target state.

The size of the numerical value of the weighting factor can be set to reflect the strength of the correlation between the weighted parameter and the probability of the state value matching the target state. For example, if the correlation between the operational mode “displaying videos” and the target state of a battery fill level of 25% at 6 pm not being reached by the user is stronger than the correlation between the operational mode “playing music” and the target state of a battery fill level of 25% at 6 pm not being reached by the user (e.g. because the display of videos leads to a more rapid decrease in battery fill level than playing music), both operational modes may be associated with a negative weighting factor, but the weighting factor associated with the operational mode “displaying videos”, e.g., −10, may be larger than the weighting factor associated with the operational mode “playing music”, e.g., −3.

The same can hold true for positive weighting factors. For example, historical data may indicate the operational mode “reading” at lunch time is strongly associated with the target state of a battery fill level of 25% at 6 pm being reached (e.g. because the user then does not watch energy-intensive videos). In this case, the weighting factor associated with the operational mode “reading” would be positive, e.g., 10. Historical data may indicate further that the operational mode “music” at lunch time is only loosely, but positively correlated with the target state of a battery fill level of 25% at 6 pm being reached. In this case, the weighting factor associated with the operational mode “music” would be positive but of a smaller numerical value, e.g., 5.

The numerical value of each weighting factor can be determined using a fitting method based on the function according to Formula 1. For example, the function according to Formula 1 may be fitted, which preferably includes the finding of the optimal values of the weighting factors, using historical data relating to a particular user from other situations in which the screen time, context and state value are known. The method to do the fitting may be chosen at will.

For example, as a loss function for regression the mean squared error between the predicted values of the function in historical data (output of the function applied to the data) and the actual observed values of the state value can be used. Then, the weighting factors can be initially set to a certain value (e.g., all of them 0) and iteratively changed using, e.g., Gradient Descent until a difference below a desired threshold is reached. Alternatively, a fixed number of iterations can be performed.

In other words, according to an embodiment of the invention, the device can be configured to retrieve historical data relating to a particular user and generate, for example by using a regression fitting method and the historical data, for this particular user for each mode of operation a function predicting the state value depending on the length of screen time (see, e.g., FIG. 4 for exemplary functions). Alternatively or additionally, the device can be configured to extract at least one weighting factor or multiple weighting factors from each function predicting the state value depending from a length of screen time.

According to an embodiment of the invention, the device or method may involve a plurality of models or functions, wherein each model or function corresponds to a specific situational parameter (that can be an interaction variable), specific mode of operation of the device, and/or specific user.

The state value of the user and/or device can be detected or inferred in real-time, preferably on a time-instant by time-instant basis. Additionally or alternatively, the context of the user and/or device or at least one situational parameter of the user and/or device can be detected or inferred in real-time, preferably on a time-instant by time-instant basis.

A device or method according to the present invention can also be configured to derive for at least one time-instant a derivative of at least one of the functions, preferably a function following the general formula given as Formula 1, in order to determine for this time instant a change or projected change of the state value.

A device according to the present invention may thus be configured to detect a change of the state value for a given time instant, e.g., a specific time point in screen time in the example in FIG. 3. For example, if the state value is the battery fill level, for each time instant of screen time, it can be detected how the battery level changes. E.g., at three minutes of screen time, the battery level decreases at a rate of −1, and after ten minutes of screen time the battery level decreases at a rate of −2. Turning to the example in FIG. 3, e.g., at five minutes of screen time, the wellbeing score increases, e.g., with a rate of 1.2, and after twenty-five minutes of screen time the wellbeing score decreases at a rate of −1.

In the next step, the inferred state value is compared to a target state. The target state may be regarded as a target state value or a target range of state values, for example, the target state may correspond to a range of wellbeing scores of 6 or above. The target state may also correspond to a range of battery fill level of 25% or above.

In the context of the present invention, the user preferably is a healthy individual and in examples in which a wellbeing score is mentioned, this preferably means that the wellbeing of a healthy individual is to be improved. The present invention involves controlling a specific technical system or process, e.g., a smartphone or a process or mode of operation running thereon, based on data relating to a user and also taking into account a situational context of the user to achieve a defined target state, e.g., a desired battery fill level at a certain time point. Data acquisition and analysis are used to optimize the operation of a device to achieve a desired target state, e.g., a desired battery fill level, wherein the situational context of the device and/or user is taken into account. The present invention may be applied to a device such as, e.g., a laptop, a tablet, a smartphone, a smart watch or any other suitable electronic device.

In the present example, the state value of the user is below the target state because the inferred wellbeing score is 4, and the target state is 6. The state value of the device is in the target state because the inferred or measured battery fill level is 28%, and the target state is 25% or above. As the inferred state value of the user corresponding to a wellbeing score is 4 in this example, it does not match the target state and also does not fall within a tolerance range that may be set at, e.g., a score of 5.5.

Thus at least one action pertaining to the operation of the device is taken, preferably by a control unit of the device. For example, a recommendation may be output to the user to switch from the operation of the device for watching videos on a social media platform to an operation of the device for playing music. This recommendation is preferably based on a prediction that the recommended operation of the smart device (playing music in this example) will improve the state value of the user, e.g., the wellbeing score of the user, and thus bring the state value closer to the target state. In addition to that, changing the operational mode of the device from the energy intensive display of videos to the less energy intensive playing of music will save battery life and thus prolong the time during which the state value of the device (battery fill level of 28% or above) matches the target state (battery fill level of 25% or above in the present example). In this way, the available energy resources of the smart device are selectively allocated to operational modes of the smart device that improve the wellbeing of the user. In other words, in this example the invention assists the user in using the available limited energy resources of the smart device in an optimized way for reaching a target state.

The method may be performed automatically and without requiring active input by the user. For example, physiological data or parameters of the user may be monitored to distinguish operational modes of the device the user claims to experience as associated with a high wellbeing score, whereas objectively these operational modes reduce the wellbeing score, as detected, e.g., through a high heart rate in a sedentary user. Thus, the method may be configured to infer the state value of the user based on measured data.

Alternatively or additionally, the user may provide input regarding his or her state value, e.g., by indicating the current perceived wellbeing score. Similarly, the target state and/or the tolerance range may be inferred or input/set by the user. For example, if the target state is inferred, it may be inferred from historical data of the user that the user regularly works until 8 pm. Thus, the inferred target stage may correspond to a battery fill level at 25% at 6 pm because in the last two hours of works the user regularly uses 10% of battery fill level. Alternatively, it may be inferred that a wellbeing score of 6 is desirable when the user is in company and that this score is possible based on historical data relating to that user.

According to an embodiment of the invention, the action relating to the operation of the device is outputting a recommendation, in particular a recommendation regarding a restriction or extension of screen time and/or a recommendation regarding switching the operational mode of the device from the first operational mode to a second operational mode.

For example, a model may be used to infer a function of a state value in relation to a length of screen time for a given operational mode of the device in a given context.

According to an embodiment of the invention, the action relating to the operation of the device is restricting screen time and/or suppressing notifications for a period of time predicted to bring the state value closer to the target state. According to an embodiment of the invention, the method comprises:

inferring by means of a model a function of a state value in relation to the length of screen time, wherein the detected situational parameter of the user and the detected first operational mode of the device are taken as constants;

predicting, based on the function, the length of screen time during which the inferred state value matches the target state or falls into a tolerance range surrounding the target state; and

based on the prediction, restricting or extending screen time of the user and/or outputting a recommendation.

For example, the function may indicate that for the situational parameter “location” corresponding to “at home” and the operational mode “playing music”, a screen time of 20 to 45 minutes results in the state value matching the target state. The term screen time denotes the length of time in which the device is operated in a given operational mode and/or the length of time during which the user interacts with the device.

According to an embodiment of the invention, the method comprises:

inferring by means of a model a function of a state value in relation to a length of screen time for the detected first operational mode of the device and another operational mode of the device, wherein the detected situational parameter of the user is taken as a constant;

predicting, based on the function, for each operational mode a length of screen time during which the inferred state value matches the target state or falls into a tolerance range surrounding the target state;

selecting, based on the prediction and preferably a present time instant, a second operational mode; and

if a detected length of screen time of the user for the first operational mode of the device has reached the limit of the predicted length of screen time for the first operational mode during which the inferred state value matches the target state or falls into a tolerance range surrounding the target state, switching the operational mode of the device from the first operational mode to the second operational mode or recommending to do so.

For example, after 45 minutes of operating the device for playing music, the device may issue a recommendation to the user to change to the operational mode “reading” because the function indicates that for this operational mode a screen time of 50 to 90 minutes results in the state value matching the target state. Additionally, operating the device for reading may be less energy consuming than playing music.

Another embodiment of the invention involves the following elements: the model infers a function of a state value in relation to the length of screen time for the detected first operational mode of the device and a plurality of other operational modes of the device; the plurality of other operational modes of the device are ranked based on the predicted length of screen time for each operational mode during which the inferred state value matches the target state or falls into a tolerance range surrounding the target state; and the second operational mode is selected based on the ranking of the operational modes and/or a detected length of screen time of the user for the first operational mode of the device. A separate function is generated for each operational mode. For each moment in time, a second operational mode may be selected. Thus, the selected second operational mode depends on the present time instant, as illustrated, e.g., in FIG. 4.

According to an embodiment of the invention, the method comprises the following steps:

extracting a habitual screen time pattern comprising a time instant from historical data relating to the user and/or device;

comparing the habitual screen time pattern on a time-instant-by-time-instant basis to a screen time pattern predicted by the model to be associated with the target state; and

if the comparison indicates that the habitual screen time pattern does not match the screen time pattern predicted to be associated with the target state or does not fall into a tolerance range surrounding the screen time pattern predicted to be associated with the target state, taking the at least one action relating to the operation of the device, wherein the at least one action preferably relates to that time instant of the habitual screen time pattern predicted by the model to require the minimum changes for reaching the target state. This may increase the acceptance of the method or system by the user because the method or system interferes with the user's habitual device usage as little as possible.

For example, if the target state relates to battery fill level, and the user regularly reads the news for sixty minutes on the device every evening, but only occasionally watches videos on the device during lunch for 20 to 25 minutes, the method or system may restrict screen time during the operational mode of watching videos during lunch time because this seems to be a less fixed and important element of the user's screen time pattern. In other words, interfering with screen time at a time instant during which the user appears to have a less fixed routine will most likely be accepted by the user more readily.

According to an embodiment of the invention, the method comprises the following steps: inferring a first state value for a first time instance and a second state value for a second time instant; evaluating whether a distance between the first state value and the target state is equal, larger or smaller than a distance between the second state value and the target state; and indicating the result of the evaluation to the user. In other words, trends may be analyzed in the state value for a given operational mode of the device. The first state value corresponding to the first time instant and the second state value corresponding to second time instant relate to the same operational mode of the device. For example, when the device is operated to play music, the state value corresponding to a wellbeing score of the user may be 4 after five minutes and may be 5 after twenty minutes. If the target state corresponds to a wellbeing score of 6, then the trend shows that the state value moved closer to the target state. This indication may be indicated to the user to encourage the user to continue to play music.

Similarly, if the target state relates to the battery fill level, e.g., a battery fill level of 10% after forty minutes, and the device is operated to play music, the state value corresponding to a battery fill level may be 29% after five minutes and may be 27% after twenty minutes. Based on this battery usage, the target state will be reached because the state value drops slowly enough for the target state to be reached. Thus, an indication may be output to the user to encourage the user to continue to play music and not to switch to videos or another energy intensive operational mode. For example, it can be recommended to extend screen time for this operational mode.

Another aspect of the invention relates to a device configured to adapt the operation of the device to achieve a desired target state. The device may be any smart electronic device such as a smartphone, table, laptop, computer, etc.

All features disclosed in the context of the method relate equally to a device and vice versa, even though not all of these features or combinations thereof may be explicitly disclosed herein for the sake of brevity.

A device according to the present invention configured to adapt the operation of the device to achieve a desired target state, comprises:

a detection unit configured for detecting a length of time a user interacts with the device, in particular a screen time, for detecting a first operational mode of the device during which the device is operated during the time the user interacts with the device, and for detecting at least one situational parameter of the user; and

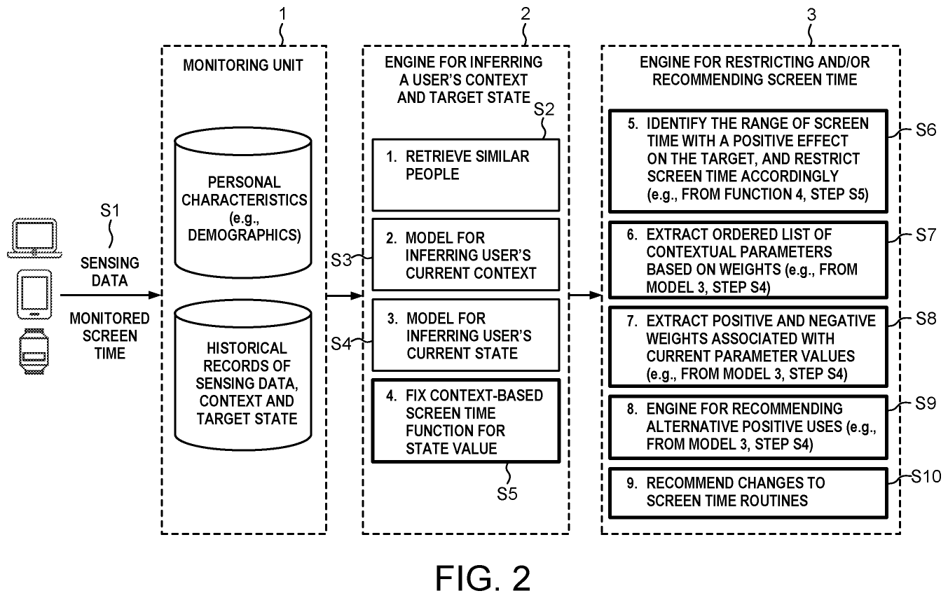

an evaluation unit configured for inferring a state value of the user and/or device based on the monitored time length and the detected operational mode of the device and the situational parameter of the user, for comparing the inferred state value of the user and/or device to a target state and evaluating whether the current state value matches the target state or falls into a tolerance range surrounding the target state, wherein the device is configured for taking an action relating to the operation of the device if the evaluation result indicates that the state value does not match the target state or does not fall into the tolerance range surrounding the target state. In one embodiment, the action relating to the operation of the device is outputting a recommendation, in particular a recommendation regarding a restriction or extension of screen time and/or a recommendation regarding switching the operational mode of the device from the first operational mode to a second operational mode. The detection unit can be a monitoring unit, for example a monitoring unit as shown in FIG. 2.

In one embodiment, the action relating to the operation of the device is restricting screen time and/or suppressing notifications for a period of time predicted to bring the state value closer to the target state.

According to an embodiment of the invention, the evaluation unit comprises a model configured to infer a function of a state value in relation to a length of screen time, wherein the detected situational parameter of the user and the detected first operational mode of the device are taken as constants, and configured to predict, based on the function, a length of screen time during which the inferred state value matches the target state or falls into a tolerance range surrounding the target state, and the device is configured to, based on the prediction, restrict or extend screen time and/or output a recommendation.

According to an embodiment of the invention, the evaluation unit includes a model configured to infer a function of a state value in relation to a length of screen time for at least the detected first operational mode of the device and another operational mode of the device, wherein the detected situational parameter of the user is taken as a constant, and configured to predict, based on the function, for each operational mode a length of screen time during which the inferred state value matches the target state or falls into a tolerance range surrounding the target state, and configured to select, based on the prediction, a second operational mode, and wherein the device is configured to switch the operational mode of the device from the first operational mode to the second operational mode or recommend to do so if a detected length of screen time of the user for the first operational mode of the device has reached the limit of the predicted length of screen time for the first operational mode during which the inferred current state matches the target state or falls into a tolerance range surrounding the target state.

According to an embodiment of the invention, the model is further configured to infer a state value in relation to a length of screen time for the detected first operational mode of the device and a plurality of other operational modes of the device, configured to rank the plurality of other operational modes of the device based on the predicted length of screen time for each operational mode during which the inferred state value matches the target state or falls into a tolerance range surrounding the target state, and configured to select the second operational mode based on the ranking of the operational modes and/or a detected length of screen time of the user for the first operational mode of the device.

According to an embodiment of the invention, the evaluation unit includes a model configured to extract a habitual screen time pattern including a time instant from historical data relating to the user, configured to compare the habitual screen time pattern of the user on a time-instant-by-time-instant basis to a screen time pattern predicted to be associated with the target state, and configured to identify that time instant of the habitual screen time pattern predicted by the model to require the minimum changes for reaching the target state if the comparison indicates that the habitual screen time pattern of the user does not match the screen time pattern predicted to be associated with the target state or does not fall into a tolerance range surrounding the screen time pattern predicted to be associated with the target state, and wherein the device is configured to take an action relating to the operation of the device if the comparison indicates that the habitual screen time pattern of the user does not match the screen time pattern predicted to be associated with the target state or does not fall into a tolerance range surrounding the screen time pattern predicted to be associated with the target state, and wherein the action preferably relates to that time instant of the habitual screen time pattern predicted by the model to require the minimum changes for reaching the target state.

According to an embodiment of the invention, the evaluation unit includes a model configured to infer a first state value for a first time instance and a second state value for a second time instant, wherein the first and second state values are inferred using the same function, and configured to evaluate whether a distance between the first state value and the target state is equal, larger or smaller than a distance between the second state value and the target state, and wherein the device is configured to indicate the result of the evaluation to the user.

In another embodiment, a method comprises:

detecting a period of time during which a user interacts with a smartphone;

detecting a first operational mode in which the user interacts with the smartphone during the period of time;

identifying a first situational context in which the user is interacting with the smartphone;

determining an interaction benefit based on the period of time, the first operational mode and the situational context;

determining whether the interaction benefit equals or exceeds a target level; and

if the interaction benefit does not equal or exceed the target level, recommending that the user interacts with the smartphone in a second operational mode.

The method can further include the step: if the interaction benefit does not equal or exceed the target level, recommending that the user restrict an amount of time during which the user engages in the first operational mode. The method can further include the step: if the interaction benefit does not equal or exceed the target level, suppressing notifications from the smartphone relating to the first operational mode. The target level can correspond to a condition selected from the group consisting of: a desired battery level and a desired device utilization level. The interaction benefit can be determined as a function of the period of time, and preferably the first operational mode and the situational context are constant in the function.

The method can further include the step: determining, based on the function, the maximum amount of time during which the user can engage in the first operational mode and maintain the interaction benefit above or at the target level. The method can further include the step: preventing the user from interacting with the smartphone in the first operational mode when the period of time during which the user has interacted with the smartphone exceeds the maximum amount of time. The interaction benefit can be determined as a function of both the period of time during which the user interacts with the smartphone in the first operational mode and a second period of time during which the user interacts with the smartphone in the second operational mode, and wherein the situational context is constant in the function.

The method can further include the step: ranking a plurality of operational modes according to a maximum amount of time during which the user can engage in each operational mode and still maintain the interaction benefit above or at the target level; and recommending that the user interacts with the smartphone in the second operational mode based on the second operational mode having a highest ranking. The interaction benefit is determined as of a first time instant, and the period of time ends at the first time instant. The method further includes determining a second interaction benefit as of a second time instant; and indicating to the user whether the second interaction benefit is greater than, equal to, or less than the interaction benefit determined as of the first time instant. The situational context identifies a context selected from the group consisting of: a location of the user, an activity undertaken by the user, and a category of persons accompanying the user.

Another embodiment of the invention is directed to a system comprising:

a timer that detects a period of time during which a user of the system interacts with a smartphone;

a mode detector that identifies a first operational mode in which the user interacts with the smartphone during the period of time;

a sensor adapted to identify a situational context in which the user is interacting with the smartphone;

an evaluation unit adapted to determine an interaction benefit based on the period of time, the first operational mode and the situational context, wherein the evaluation unit determines whether the interaction benefit equals or exceeds a target level; and

a screen of the smartphone on which a recommendation is displayed to the user if the evaluation unit determines that the interaction benefit does not equal or exceed the target level. The recommendation can be that the user should switch from interacting with the smartphone in the first operational mode to interacting with the smartphone in a second operational mode. The recommendation can be that the user should limit an amount of time during which the user interacts with the smartphone in the first operational mode.

The system can be configured to suppress notifications to the user from the first operational mode if the evaluation unit determines that the interaction benefit does not equal or exceed the target level. The evaluation unit can be configured to determine the interaction benefit as a function of the period of time, wherein the first operational mode and the situational context are constant in the function. The situational context can be a context selected from the group consisting of: a location of the user, an activity undertaken by the user, and a category of persons accompanying the user.

In another embodiment, a method involves determining personal characteristics applicable to a user of a smartphone. Sensing data corresponding to how the user is interacting with the smartphone is detected. A situational parameter corresponding to a context in which the user is interacting with the smartphone is detected. An operational mode in which the user is interacting with the smartphone is detected. A maximum amount of time during which the user can interact with the smartphone in the operational mode and still maintain a target wellbeing level is determined based on the personal characteristics, the sensing data and the situational parameter. A period of time during which the user is interacting with the smartphone in the operational mode is detected. If the period of time exceeds the maximum amount of time, it is recommended that the user interacts with the smartphone in a second operational mode.

The personal characteristics can be selected from the group consisting of: a gender of the user, an age of the user, an ethnicity of the user, and a personality score of the user. The sensing data can be selected from the group consisting of: a step count sensed while the user is interacting with the smartphone in the operational mode, GPS coordinates of the smartphone while the user is interacting with the smartphone in the operational mode, total data consumption of the smartphone while the user is interacting with the smartphone in the operational mode, ambient light level while the user is interacting with the smartphone in the operational mode, and ambient noise level while the user is interacting with the smartphone in the operational mode. The context corresponding to the situational parameter can be selected from the group consisting of: a location of the user, an activity undertaken by the user, a category of persons accompanying the user, and a time of day during which the user is interacting with the smartphone. The method further involves suppressing notifications from the smartphone relating to the operational mode if the period of time exceeds the maximum amount of time. The method further involves recommending that the user stops engaging in the operational mode if the period of time exceeds the maximum amount of time.

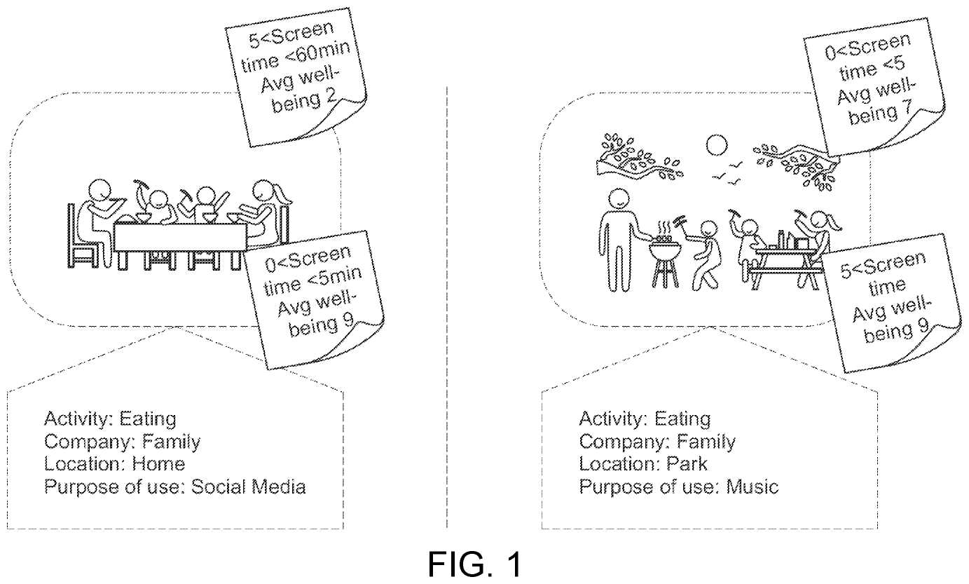

FIG. 1 illustrates the general concept of the context-dependent impact of screen time on a target state. The left-side panel of FIG. 1 shows an example in which the user is eating with his family at home and uses his smartphone for social media. In this context, using the smartphone for extended periods of 5 to 50 minutes leads to a low wellbeing score of 2. Using the smartphone for only short periods of 0 to 5 min leads to a high wellbeing score of 9. In this context and for this purpose, smartphone use is associated with a negative effect on wellbeing.

The right-side panel of FIG. 1 shows an example in which a user is eating with his family in the park and uses his smartphone for playing music. In this context, using the smartphone for only short periods of 0 to 5 min leads to an acceptable wellbeing score of 7. Using the smartphone for prolonged periods of more than 5 min, however, leads to a high wellbeing score of 9. In this context and for this purpose, smartphone use is associated with a positive effect on wellbeing.

As the example above illustrates, context plays a significant role when analyzing the associations between the length of screen time, an operational mode of a device and a target state, such as wellbeing or battery fill level. Moreover, context can hardly be untangled, as one can be in different context categories (also referred to as situational parameters) at the same time (location, activity, company etc.), as illustrated in FIG. 1, and context category has a different significant role on the target state. The situational parameter detected according to the present invention may thus be, e.g., location, activity, company, interaction of the user with others, the time of the day or any other parameter capturing the situational context of the user.

The examples in FIG. 1 illustrate how different contextual category values and the operational mode of the device (also referred to as a purpose of use) need to be prioritized appropriately in order to reach a decision on whether to recommend or restrict device use and for how long to recommend or restrict device use, as well as to advise the user of alternative operational modes of the device predicted to bring the current state closer to the target state (also referred to as target condition).

In another example, the target condition can be the battery fill level, such that the method aims to optimize the time when to use the device based on the situational parameter (e.g., company and location), the operational mode (e.g., playing music), and sensing data (e.g., Wi-Fi connected) in order to arrive at the end of the day with the battery level within a desired range.

In this regard, the present invention may thus be regarded as a personalized method or system to restrict or recommend an extension of primarily screen time and secondarily notifications, based on a prioritization model of existing context categories of a user based on past historical data from the user and/or similar users, as well as to identify alternative operational modes when considering a target state, and recommend alternative screen time or operational mode routines when considering a target state.

The present invention may be used for recommending screen time based on a user's context or situational parameters as well as current and historical screen time measurements, coupled with a target state. This invention for example contextualizes screen time into individual patterns of behavior, as well as the target condition (such as subjective wellbeing, or battery level consumption) in order to create an engine for recommending an optimal screen time (that can be restricting or extending the number and/or duration of screen time slots).

This invention preferably defines a personalized model for optimizing screen time by factoring in a user's context, personal characteristics, as well as historical data (both passive and active reports relating to the state value and/or target state) from the user and similar users in order to restrict (or extend) screen time use of the user. Active reports are preferably based on active input from the user, e.g., the user subjectively rating his or her wellbeing, whereas passive reports rely on acquired data, e.g., physiological data pertaining to the wellbeing of the user. The model can also be used to recommend alternative operational modes or screen time patterns in order to optimize device usage for attaining a target state.

A method according to the present invention involves: (1) inferring a users' context and target condition from the user's data as well as data from similar users, (2) given a fixed context and target condition, identifying the range of screen time for positive and negative effects on the target condition, and restricting or extending the device usage accordingly, preferably both in terms of screen time as well as notifications, (3) unpacking the positive and negative interaction elements of the user's context in order to recommend alternative positive uses considering the target condition, and (4) based on the additional parameters (e.g., avoiding night time 12 am-6 am) defining the recommended space of screen time patterns in general for the user based on the user's routine behavior. This is preferably performed by minimizing the change in screen time patterns, wherein change is preferably represented as a quantified difference between the current screen time patterns and the recommended space of screen time patterns, in order to recommend the optimal screen time routine for the user given a target condition.

FIG. 2 illustrates a system according to an embodiment of the present invention. The system includes a monitoring unit 1, an engine 2 for inferring a user's context and target state, and an engine 3 for restricting and/or recommending screen time.

In this example, the monitoring unit 1 monitors or detects in step S1 (1) the length of screen time, (2) contextual data such as location, company, interaction of the user with other users, movement, time of the day, season etc., (3) data pertaining to a state value or target state, such as wellbeing, battery consumption, battery fill level, and (4) personal characteristics of the user, such as gender, age, personality, individual preferences etc.

All these variables (1)-(4) can be monitored either by relying on active data collection, e.g., user's self-reports and diaries, or automatically measured, inferred or estimated, e.g., by using smartphone sensor data or data from sensors in wearables or smart-watches. The monitoring unit 1 accesses historical records relating to the variables (1)-(4) of the user.

If no such historical records are available for a given user, the engine 2 may be used in step S2 to retrieve profiles of people similar to the user from a database based on data from the monitoring unit. The engine 2 includes a model for inferring in step S3 the user's current context based on for instance the user's historical mappings between past sensing data (including screen time) and inferred context, as well as historical mappings from similar people. In one embodiment, engine 2 is a software module executing on the user's smartphone as part of a mobile app. The model for inferring used in step S3 is a submodule of the software module that solves a function or implements a learning algorithm. Alternatively, the context may be specified by the user, for example, the user may enter into the device that the user is at work with a specific colleague.

The user's context can include the following items: activity (e.g., eating), company (e.g., family), location (e.g., park), purpose of device use (e.g., social media), and thoughts (e.g., cooking class). These may be regarded as examples of situational parameters of the user.

The engine 2 also includes a model for inferring in step S4 the user's current state (which may be regarded as the state value of the user in a given context) based on the user's historical sensing data (including screen time) and inferred context from step S3, as well as historical mappings from similar people. Alternatively, the user's current state may be specified by the user, for example, entering into the device the fact that the user is experiencing a wellbeing score of 4. Similarly, the target state, such as a wellbeing score of 6 or a battery fill level of 25% at 6 pm, may be set by the user or an external source or inferred based on historical records of the user or similar people.

The engine 2 can use the model in step S5 to generate a function that, given a fixed context and varying values for the screen time, retrieves a range for the screen time such that it has a desired effect on the target state. In other words, the function predicts state values, such as a battery fill level or a wellbeing score, for varying lengths of screen time (e.g., after 5 minutes of screen time, the battery level will be 25% and/or the wellbeing score will be 7) given a fixed context including a fixed operational mode of the device (e.g., being at home with friends and using the device for playing music). An example of such a function is shown in FIG. 3.

The function is used to predict for how much time the smart device should be operated in a given operational mode in a given situational context. If the predicted state value does not fall within a range of values set as the target state (e.g., after 20 minutes the predicted battery fill level is 25%, but the target state is to achieve 28% battery fill level after 30 minutes), screen time can be restricted or a recommendation can be issued prompting the user to change to a different operational mode of the device.

The engine 2 generates different functions for different operational modes and a common given context to determine the optimal operation of the device in a given situational context, e.g., when alone at home, using the device for prolonged periods of reading leads to a higher battery fill level and/or wellbeing score than using the device for prolonged periods of watching videos on social media.

Alternatively or additionally, the engine 2 generates different functions for the same operational mode and varying situational contexts to determine the optimal situation in which the device is operated in the given operational mode. For example, when the situational context indicates that the user is alone at home, using the device for prolonged periods of watching videos on social media may lead to a low wellbeing score and rapid drain of the battery fill level. On the other hand, when the situational context indicates that the user is in a bar with friends, using the device for prolonged periods of watching videos on social media may lead to a high wellbeing score, so the disadvantages of the rapid drain of the battery fill level are offset by the gain in wellbeing.

Based on the analysis results of the engine 2, the engine 3 in step S6 restricts or recommends extending screen time for a given operational mode of the device. In other words, given the extracted screen time range under the current context and the current monitored screen time, the device restricts or recommends the device usage accordingly. If it has been determined by engine 2, in particular the function or model comprised therein, that the current screen time exceeds the limit resulting in the target state identified by the function or model for the current context, the display of notifications to the user is suppressed while the user is in this context.

This may be illustrated based on the exemplary function in FIG. 3. For example, the function in FIG. 3 indicates that the state value, e.g., the wellbeing score of the user, is above a threshold of 6 for a screen time length ranging from 15 to 31 min given a fixed context and operational mode of the device, e.g., reading/watching social media on the device alone at home. If the target state is defined as a wellbeing score of 6 or above, then a screen time between 15 to 31 minutes of using the device for social media when the user is alone at home results in the target state, in this example the user experiencing a wellbeing score of 6 or above.

In one implementation, after 31 minutes of screen time using the device for reading when the user is alone at home, the display of notifications to the user is suppressed while the user is in this context. If the context changes, e.g., the user receives company or changes to a different operational mode of the device, the suppression of notifications may be eased.

In addition, the system can be configured to suggest an alternative operational mode to the user after the user has reached for a given operational mode of the device the end of the screen time predicted by the model or function to result in the state value matching the target state or has reached a tolerance range surrounding the end of screen time. For example, turning to the function in FIG. 3, after the user has reached 31 minutes of reading/watching social media on the device alone at home, the engine 3 may draw on the results of the model of engine 2 to recommend an alternative operational mode predicted to achieve the target state for longer periods of screen time. This concept is illustrated by the exemplary functions in FIG. 4.

FIG. 4 shows that the user has reached 30 minutes of reading/watching social media on the device alone at home, as indicated by the vertical dashed line in FIG. 4. The user is thus approaching the end of screen time for this context and operational mode of the device predicted in step S5 to result in the state value matching the target state (a wellbeing score of above 6 in this example). For example, the tolerance range surrounding the end of the predicted beneficial screen time (30 minutes) may be 5 minutes, 3 minutes or 1 minute. The time length of the tolerance range may be set at will.

For recommending an alternative purpose of use predicted to result in the state value matching the target state, different situational parameters of a given context of the user, e.g., location (at home); company (with friends); time of day (7 pm); activity (after exhausting exercise) may be weighted to determine which of these parameters is most decisive for determining how the user experiences a given context.

In other words, the system or method can be configured for untangling different situational parameters of a given context and extracting the weights of each parameter based on current screen time and leading to the user's current state value, personalized for the user under analysis either based on historical data from the user under analysis or from historical data from similar users.

Many times users are in a mixed context, such as eating with family members, at home, while listening to music or watching TV on a device. Allocating a weighting factor to reflect the priority and weight of each of these situational parameters on bringing the state value to the target state is crucial and allows for a more realistic restriction or recommendation engine optimized for the target state.

In step S7, the engine 3 can be configured to extract an ordered list of weighted situational parameters of a given context of the user based on the analysis of engine 2 in steps S3 and S4. For example, the situational parameters of a given context of the user may be as follows: location (at home); company (with friends); time of day (7 pm); activity (after exhausting exercise). Historical data of this particular user may indicate that whenever the user is with friends (situational company: with friends) the wellbeing score is 7 and the battery fill level rapidly decreases, regardless of the time of day or the location.

Thus, the situational parameter “company” can be weighted more heavily than the situational parameters “time of day” and “location”. For example, the situational parameter “company” may be associated with a weighting factor of 30, and the situational parameters “time of day” and “location” may be associated with weighting factors 5 and 8, respectively. In this example, the ordered list includes the situational parameters in the order “company” with a weighting factor of 30, “location” with a weighting factor of 8, and “time of day” with a weighting factor of 5. In other words, the model can be configured to generate a weighting factor for each situational parameter of a context of the user and to generate an ordered list of the situational parameters based on the weighting factors.

The weighting factors can be generated based on historical data of a particular user and/or based on historical data of other people determined to be similar to the particular user, e.g., as outlined in step S2. For example, historical data relating to similar users may be retrieved and ranked based on the similarity of each user to the particular user and, e.g., the historical data sets pertaining to the three most similar other users are selected to generate the weighting factors for the particular user. From the ordered list generated in step S7, the situational parameters determined to be most relevant from the given context, in the example, the situational parameter “company” associated with the largest weighting factor, can be selected.

It can then be determined which mode of operation of the system results in the state value matching the target state or tolerance range for which length of screen time, as shown by the exemplary functions illustrated in FIG. 4. For example, in step S8, the engine 3 extracts positive and negative weights and the situational parameters associated therewith of a context the user currently experiences from the ordered list generated in step S7. For example, for a current context, only the situational parameters “company” and “location” are available. Based on historical data it is known that for a particular user, the situational parameter “company” is associated with a weighting factor of 30 and the situational parameter “location” is associated with a weighting factor of 8. Thus, the situational parameters “company” and “location” are extracted together with the associated weighting factors 30 and 8. In this example, these weighting factors are positive numbers. However, weighting factors may also be negative numbers, such as (−30) or (−8).

For example, given a fixed context with the situational parameter “company: with friends” with the weighting factor of 30 and the situational parameter “location: at home” with the weighting factor of 8, model can be used to predict for each mode of operation of the device the length of screen time during which the state value matches the target state or tolerance range, as shown by the exemplary functions illustrated in FIG. 4. In other words, given the weighting factors, the screen time for each mode of operation of the device predicted to result in the state value matching the target state or tolerance range thereof as shown in FIG. 4, and the current target state, in step S9 the engine 3 identifies and/or recommends one or more alternative modes of operation of the device, especially when the user has reached the limit in screen time. The alternative mode or modes of operation of the device are selected based on a prediction using the function to determine the length of screen time that results in the state value matching the target state or a tolerance range thereof.

In step S9, the engine 3 in this example outputs a recommendation regarding an alternative mode of operation of the device predicted by the model to be suited for achieving the target state, e.g., changing from the display of music videos to playing only the music in order to achieve the target state of 28% battery fill level at 6 pm. In order to determine an optimal screen time routine, the device can further be configured to analyze a set or space of all possible screen-use patterns (when and for how long) that would have a desired impact on the state value, in particular bring the state value closer to the target state.

The device can be configured to compare the current use or momentary operational mode of the device or the current habits (estimated from a longer historical usage) of screen time with this space of “allowed/recommended” screen time. In other words, the device may be configured to compare the actual screen time pattern of the user to an ideal screen time pattern predicted by the device to be optimal for the state value to match the target state or to fall within a tolerance range surrounding the target state.

The device may further be configured to identify one or more time periods in the user's actual screen time pattern that show the smallest deviations from the ideal screen time pattern determined by the device. Thus, the device may be configured to recommend changes to the actual screen time pattern of the user for these identified time periods to ensure at least partial compliance of the actual screen time pattern to the ideal screen time pattern with the minimal amount of changes to the user's screen time pattern being required. In other words, the device may be configured to compare the user's actual screen time pattern to an ideal screen time pattern determined by the device in order to find those recommendations that would require the smallest change in screen patterns for routine changes in favor of reaching the ideal screen time pattern. This can result in recommendations that are momentary (meant to be done at that moment) or in habits (meant to change current habits), or both (changes in habits that imply a change at that moment).

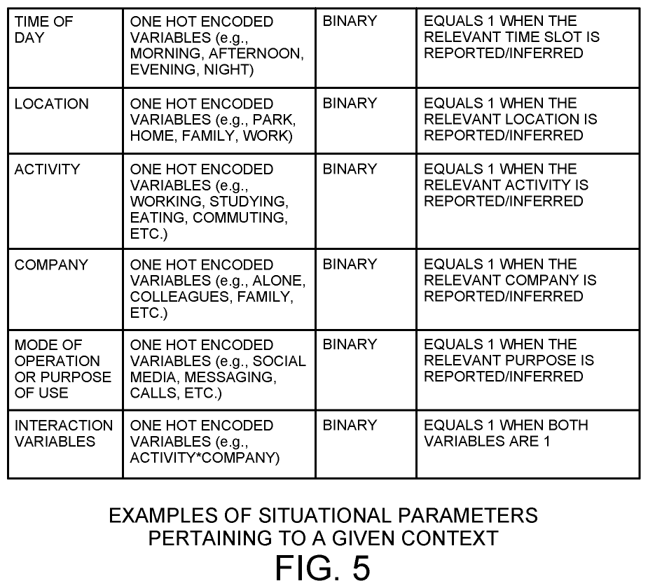

The present invention is further illustrated by way of a detailed example as outlined below. Examples of situational parameters are listed in the table of FIG. 5. The situational parameters are not limited to the examples. The situational parameters may be singular variables, such as location: at home, which equals 1 if it has been detected that the user is at home and which equals 0 if it has been detected that the user is not at home. The situational parameters may also be interaction variables, such as activity:sports*company:friends, which equals 1 if it has been detected that the user is playing sports with at least one other person categorized as a friend and which equals 0 if it has been detected that the user is not playing sports or is not with at least one other person categorized as a friend.

FIG. 5 is a table of sample situational parameters that pertain to a given context. At least one situational parameter of the user is detected. Multiple situational parameters of the user may be detected. If multiple situational parameters of the user are detected, at least one of the situational parameters can be an interaction variable.

In one embodiment, the monitoring unit 1 is configured to retrieve at least one or more of the following items of information:
a. Personal characteristics of a user, such as demographics, individual wellbeing set-points, personality, user's preferences, etc.
b. Historical and current sensing data, e.g., from sensors of smart devices used by the users, wherein the sensing data preferably includes screen time data.
c. Historical and current context data, preferably situational parameters, such as, e.g., company, location, activity, purpose of use of the device. The context data may be inferred from sensing data from sensors or may be provided from another source, e.g., by the user or a calendar entry etc.
d. Historical and current state value data, e.g., past records of wellbeing scores and/or past records of battery level during or at the end of the day.
e. Historical mappings between past monitored contexts, screen time and past reported or inferred state values for a particular user, e.g., a wellbeing score of 6 after 20 minutes of screen time using the device to play music in the company of friends in the park, or a battery level of 22% after 20 minutes of screen time using the device to play music in the park in the company of friends.

If such mapping is not available for a given user, the system can retrieve people with similar historical patterns (e.g., contexts) and personal characteristics as described in the context of step S2 in FIG. 2. The engine 2 can include a model configured for retrieving similar people based on personal characteristics (at start) and further based on similar contexts and target states reported. The engine 2 can also include a model configured for retrieving the real-time context of the user, including the mode of operation of the device. The context of the user may be inferred with a sensing model based on sensors of the device connected to the user and/or based on past historical mappings between past monitored sensing values and inferred contexts either of the current user or similar users. Example of situational parameters relating to a user's context are provided in the table of FIG. 5. Examples of mapping between situational parameters and state values are illustrated in FIG. 1.

In other words, a system according to the present invention can be configured to detect a situational parameter or context of the user in real-time and/or automatically. If historical mappings of a particular user are not available, the context and/or situational parameter(s) of the user can be inferred from similar people's past historical mapping data retrieved by device. Alternatively, the context and/or situational parameter(s) of the user can be specified by the user, e.g., by the user inputting the user's location, activity, etc.

The engine 2 can also include a model configured for retrieving the real-time state value of the user and/or device. The real-time state value of the user can be inferred with a sensing model based on sensors of the device connected to the user, and based on past historical mappings between past monitored contexts and state values either of the current user or similar users as well as the current screen time. If historical mappings of a particular user are not available, the state value of the user can be inferred from similar people's past historical mapping data retrieved by the system. In a variation, the state value can be specified by the user, e.g., by the user inputting that she is experiencing a wellbeing score of 4 or that the device has a battery fill level of 50%.

In step S5 a function, which given a fixed context and varying values for the screen time, retrieves a range for the screen time such that it has a desired effect on the state value. For example, the function can be used to determine the length of screen time during which the state value matches the target state for a given mode of operation and given situational context of the user.

The function that infers the state value, e.g., a function as shown in FIG. 3 or 4 preferably receives as input the context (e.g., situational parameters such as location, company, activity) of the user, the user characteristics and the screen time, and with that it computes the predicted value of the state value. The function is denoted state_value=f(context, screen_time).

Given a fixed context, and leaving the screen time as variable, it is possible to predict the state value for different values of screen time. This function is denoted as state_value=f(context=fix_context,screen_time)=g(screen_time). See FIG. 3 for an example of the function and decision.

Given the extracted screen time range under the determined current context of the user and the current monitored screen time (e.g., the user has been using the device for a screen time of 30 minutes so far), the method or system may further restrict or recommend extending the device usage accordingly. Specifically, in the example of FIG. 3, the method or system restricts the screen time for the given mode of operation of the device to a range of between 15 and 31 minutes in order to ensure the state value (e.g., wellbeing) remains above the desired threshold (e.g., 6) and thus matches the target state, as indicated by the shading in FIG. 3.

If the current screen time exceeds the limit identified by the method or system under the current context, for example, if in the example of FIG. 3 the user has used the device for the given mode of operation for 40 minutes, although 31 minutes has been identified as the limit of screen time predicted to result in the state value matching the target sate, the method or system may further be configured to restrict or suppress the output of notifications on the device to the user while the user is in this context.

In another embodiment, the device or system includes or uses a model configured for unraveling the mapping between the current state value and the current context or situational parameters given a length of the current monitored screen time. This can be achieved for instance by training a machine learning model to predict the state value given the context, preferably including a mode of operation of the device, personal characteristics of the user and screen time, such as the elapsed screen time so far, e.g., 30 minutes in FIG. 4. From this model, an ordered list of contextual parameters is extracted, e.g., as outlined in step S7 in FIG. 2 that contribute to the current state value. The model is configured to extract negative and positive weights or weighting factors of the reported or inferred situational parameters, e.g., as outlined in step S8 of FIG. 2 from the list generated, e.g., as outlined in step S7 in FIG. 2.

FIG. 4 shows that, at the current screen time of the user of 30 minutes, the functions for the operational modes social media and playing music predict that these modes of operation will result in a state value (e.g., a wellbeing score of the user) that matches the target state, defined in this example as a state value of 6 or above. Thus, the modes of operation “social media” and “playing music” in this example can be associated with positive weights or weighting factors because at the current screen time and/or future screen time, these modes of operation are predicted to result in the state value matching the target state. The numerical value of each positive or negative weighting factor may scale with the length of screen time predicted by the function for each mode of operation to result in a state value (e.g., a wellbeing score of the user) matching the target state, defined in this example as a state value of 6 or above.

FIG. 4 shows that the function for the mode of operation “music” predicts that the state value will match the target state for a screen time range between 22 to 70 minutes. The function for the mode of operation “social media” predicts that the state value will match the target state for a screen time range between 15 to 30 minutes.

Because the current screen time in the example of FIG. 4 is 30 minutes (as indicated by the dashed vertical line), the mode of operation “social media” is predicted to result in the state value matching the target only for one further minute (when 31 minutes of screen time will have elapsed), whereas the mode of operation “music” is predicted to result in the state value matching the target only for 40 further minutes (starting at 30 min of screen time until 70 minutes of screen time have been reached). Thus, the positive weight or weighting factor associated with the mode of operation “music” can be a larger numerical value than the positive weight or weighting factor associated with the mode of operation “social media”.

On the other hand, in FIG. 4, at the current screen time of the user of 30 min, the function for the operational modes “calls” and “messaging” predicts that those modes of operation will result in a state value (e.g., a wellbeing score of the user) that does not match the target state, defined in this example as a state value of 6 or above. Thus, the modes of operation “calls” and “messaging” in this example can be associated with negative weights or weighting factors because at the current screen time and/or future screen time, these modes of operation are predicted not to result in the state value matching the target state.

Weights or weighting factors may be additionally or alternatively allocated to situational parameters that may be singular variables or interaction variables. In this case, the mode of operation can be fixed, e.g., social media, and the function can be used to determine the state value resulting from a screen time spent in this mode of operation for different situational parameters, e.g., using the device for 20 minutes to consume social media has a positive impact on wellbeing when the user is alone at home but has a negative impact on wellbeing when the user is at home with family. Thus, the situational parameters “company: none” and “company: family” in this example can be associated with positive and negative or weighting factors, respectively because at the current screen time and/or future screen time and the given mode of operation, these situational parameters are predicted to result in the state value matching or not matching the target state, respectively.

In case of negatively weighted situational parameters that are interaction variables, the model is preferably configured to identify that parameter which causes the negative association. The identified parameter is preferably further used in step S9. The method or system further proceeds to restrict the device usage while in the current context and mode of operation when negative weights were extracted, as outlined, e.g., in steps S9 and S10.

In case of a positive weight or weighting factor, e.g., as extracted for the modes of operation “music” and “social media” at the screen time of 30 min in the example of FIG. 4, the method or system may not restrict device usage, given that the current mapping is positive.

In step S10, the method or system preferably further retrieves the top N related purposes, given the negative parameter, which in combination with the other contextual values would have a positive impact on the current state value, and/or would allow the user to continue using the phone and further recommend the user these alternative uses. For example, the user could see the following message: “You have reached the limit of screen time use, considering your context (Eating, Home, Family, Social Media). You could switch to using the device for Music or stop using the device altogether for optimal achievement target state).”

In order to make the recommendation, all contexts except the “mode of operation” can remain constant or fixed, and the method or system can simulate the state value using the function f or functions f at the current screen time range for different modes of operation. Those modes of operation that have a predicted state value within the target state or desired range of values will be selected as recommended modes of operation. See FIG. 4 for an example.

In step S9, the recommended changes to the user's screen time pattern are preferably selected to require minimal adaptations of the user's screen time pattern in order to achieve the target state.

Considering the optimal screen time pattern for the fixed context determined using the function(s), the method or system can be configured to further analyze the routine/habitual screen time use per context and to recommend the minimal changes to the routines in order to reach a desired effect on the state value. E.g., the user usually uses the screen or device for 30-50 minutes most days during the evening at home and 20-30 minutes during lunch time at work. The device predicts that the optimal range of screen time for the evening at home is between 15-20 minutes and during lunch at work for 17-25 minutes. In this example, the system restricts or recommends reducing the screen time during the evening at home to be less than 20 minutes and does not present any recommendations for lunch time at work.

In the following, an exemplary embodiment illustrates how a person may use this invention to change the person's routine in order to reach an optimal habitual screen time, considering as a target state a defined level wellbeing and as contextual information only the time of the day. In this example, the person or user is a healthy individual. In this example, the time of the day feature is split into slots (morning, afternoon, evening and night) and can be easily inferred and not specified. Based on past reports of the user, the system builds a model to infer the state value (i.e., wellbeing score) from the time of day and the current screen time consumption (e.g., 30 minutes screen time at 7 am). Over time, the model can determine or predict by fixing the context, which screen time is optimal for the state value to achieve the target state in this context and consequently, recommend to the user when to extend or reduce the user's screen time habitual consumption considering the user's routine behavior.

While this example is restricted to smartphone use monitoring, the present invention is applicable to any digital device, such as a laptop, smart watch, etc. In this example, the user (user 1) is using an iOs Smartphone, which in this example is a device that collects background passive information from the smartphone sensors. At the start of the use of the device, the monitoring unit retrieves, e.g., through questionnaires delivered on the device, the user's demographics, e.g., gender, ethnicity, age, etc., personality scores, e.g., Big 5, Fisher temperament inventory, etc., preferences, etc. In this example, the personal characteristics of the user are as follows:

Gender: Male

Age: 22

Ethnicity: White

User 1: Big 5: Openness: 44, Conscientiousness: 78, Extraversion: 55, Agreeableness: 39, Neuroticism: 23

The device continuously monitors a number of passive sensing data streams, e.g., screen time, step count, GPS coordinates, data consumption, etc. These data streams are “passive” in the sense that they do not require active input from the user and are preferably acquired continuously. These data points are used in the spot for further processing by the device and also stored in the database as historical data. In this example, the passive sensing data of the user are as follows:

screen time: 12 minutes

step count: 1026 steps

GPS coordinates: 40.41, −3.68

data consumption: 48 Mb

device battery fill level 28%

The device continuously monitors a number of situational parameters relating to the context of the user, e.g., location, activity, company, mode of operation of the device, etc. These data points are used in the spot for further processing by the device and also stored in the database as historical data.

In this example, this data is gathered through the user's input to the device. In a different embodiment, a machine learning model, e.g., a neural network, for each situational parameter, e.g., location, activity, company, etc. can be trained using historical data and applied to the current passive sensing data. In this example, the situational parameters of the user are as follows:

Location: park

Activity: eating

Company: friends

Mode of operation of the device: social media

The device continuously monitors the state value or infers the state value using a model, the state value in this example being the wellbeing score of the user. Generally, the state value is preferably monitored, inferred or assessed in realtime on a time-instant by time-instant basis.

These data points relating to the state values are used on the spot for further processing by the device and are also stored in the database as historical data. In this example, a machine learning model trained on previous mappings between context, screen time and state value is used to infer the current target state. In this example, the state value of the user in the given context is as follows: Wellbeing score: 6

For each monitoring instance or time instant for which a state value has preferably been monitored, inferred or assessed, the mapping between context, screen time and state value is stored as historical data.

The device can retrieve the historical mappings of the current context, screen time and state value if such historical information is available, otherwise it will retrieve it from similar users. In this example, it is assumed that the mapping is available for the user and three past observations are retrieved:

Screen time: 23; Context: location: park, activity: eating, company: friends; Purpose of use: social media; Wellbeing: 4

Screen time: 5; Context: location: park, activity: eating, company: friends; Purpose of use: social media; Wellbeing: 8

Screen time: 14; Context: location: park, activity: eating, company: friends; Purpose of use: social media; Wellbeing: 6

If no such previous mappings relating to the user are available, the model can be used to retrieve mappings of people determined to be similar to the user and whose mappings and/or historical data are available. In this example, the model used is a similarity score computed on the personality traits from the Big 5 that ranks the users by their similarity score. The score used in this example is the Euclidean distance similarity between the user's Big 5 vector and the Big 5 vector of each of the other users. Those top 3 users with the lowest Euclidean distance are selected as similar users.

For example, historical data of people with the following Big 5 personality trait vectors may be available:

User 2: Openness: 21, Conscientiousness: 15, Extraversion: 72, Agreeableness: 45, Neuroticism: 89. Similarity: (95.8)

User 3: Openness: 50, Conscientiousness: 63, Extraversion: 32, Agreeableness: 69, Neuroticism: 26. Similarity: (28.5)

User 4: Openness: 53, Conscientiousness: 67, Extraversion: 49, Agreeableness: 46, Neuroticism: 19. Similarity: (17.4)

User 5: Openness: 25, Conscientiousness: 62, Extraversion: 85, Agreeableness: 22, Neuroticism: 36. Similarity: (44.4)

User 6: Openness: 79, Conscientiousness: 83, Extraversion: 44, Agreeableness: 27, Neuroticism: 32. Similarity: (20.2)

Thus, user 4, user 6 and user 3 are most similar to user 1 in terms of Big 5 personality trait vectors. Hence the historical data pertaining to users 3, 4 and 6 are retrieved to be used to infer correlations between a given context or situational parameter or situational parameters, mode of operation of device, screen time and state value.

In this example, the real-time context is received as input from the user. However, if that input is not available, a machine learning model can be trained on previous experience to infer the context. The context preferably is understood to comprise at least one situational parameter or a set of situational parameters, such as location, company or activity.

For instance, a neural network may be used that is trained on historical data from which both the passive sensing inputs and the corresponding context are available.

Preferably, for each situational parameter (location, company, mode of operation, etc.) a different model is trained to infer the situational context based on, e.g., sensor data and information relating to the mode of operation.

Then, the same set of passive sensing inputs (X) can be passed as input to the trained neural network and the inferred context is output from the model. For example, a trained neural network trained to infer whether the user has company or not may receive input from movement sensors, location data and data relating to the mode of operation of the device. If the movement sensors indicate no movement, the location is “at home” and the mode of operation is “playing music”, the user is likely alone and listening to music quietly. The inferred situational parameter “company” is thus: no company. Conversely, when the movement sensors indicate movement, the location is “at a bar” and the mode of operation is “playing music”, the user is likely dancing at a bar which implies that the user has company. The inferred situational parameter “company” is thus: company.

Similarly, e.g., movement data may be input into a trained neural network for inferring whether the user has company or not. As the movement data indicates a high level of activity, the network may infer that the user has company. The same movement data may be input into a trained neural network for inferring the activity the user is performing. From the pattern of movement data, the neural network may infer that the user is running. The same movement data may be input into a trained neural network for inferring the time of day. From the pattern of movement data, the neural network may infer that it is 7 pm because the user goes running every evening at 7 pm.

In one embodiment, the system includes a plurality of models each configured to infer a situational parameter of the user or device based on data passively obtained from the sensors present on the device or associated therewith and/or based on historical data pertaining to a user and/or historical data pertaining to at least one other user determined by the device to be similar to the user.

After the context of the user has been inferred or monitored, the device is configured to assess the state value of the user in real-time for each time instant. For this purpose, the system includes a model for retrieving the real-time state value of the user. In this example, the model used uses a function inspired by the Maxwell-Boltzman distribution. Given personal characteristics (P), passive sensing data (S), context/situational parameters (C), screen time (t) and mode of operation (also referred to as purpose of use or purpose) (U),

$$f ( P , S , C , t , U ) = \frac{b ( P , S , C , U ) {t}^{2}}{a ( P , S , C , U \text{?}} {e}^{( \frac{{t}^{2}}{2 a ( P , S , C , U )} )}$$

$$\text{?} \text{indicates text missing or illegible when filed}$$

where b(P,S,C,U) and a(P,S,C,U) are linear functions of each of the parameters, and the function f(P,S,C,t,U) is optimized by minimizing the Mean Squared Error between f(P,S,C,t,U) and the actual state values observed on historical data.

An example of a(P,S,C,U) with the P parameters being gender Male/Female (g=1 if female) and age (age numeric), S parameters being step count (steps numeric), C parameters being location_park, location_home, activity_eating, activity_working, company_friends, company_family, company_alone all binary, U being purpose_calls, purpose_social_media, purpose_music and purpose_messaging all binary:

a (P, S, C, U)=w₀+w₀g+w₂age+w₃steps+w₄location_park+w₅location_home+w₆activity_eating+w₇activity_working+w₈company_friends+w₉company_family+w₁₀company_alone+w₁₁purpose_socialmedia+w₁₂purpose_music+w₁₃purpose_messaging,

and b(P,S,C,U) constructed analogously with different weights. Preferably, each parameter is allocated a designated weighting factor, wherein weighting factors of different parameters may correspond to equal or different numerical values. Each weighting factor may be a positive or negative number.

Based on the function determined for the user and a given context comprising one or more situational parameters, the system predicts for each different mode of operation a screen time range during which the state value matches the target state or a tolerance range surrounding the target state.

Given the observed, retrieved or inferred values of the personal characteristics P_{S}, passive sensing data S_{S}, context C_{S} and purpose of use U_{S} the function to retrieve the real-time state value will be a function of screen time alone:

$$f ( P = {P}_{S} , S = {S}_{S} , C = {C}_{S} , U = {U}_{S} ) = \frac{b ( {P}_{S} , {S}_{S} , {C}_{S} , {U}_{S} ) {t}^{2}}{25 a ( {P}_{S} , {S}_{S} , {C}_{S} , {U}_{S} \text{?}} \text{?}$$

$$\text{?} \text{indicates text missing or illegible when filed}$$

Let us assume that for this example, a (P_{S}, S_{S}, C_{S}, U_{S})=10 and b (P_{S}, S_{S}, C_{S}, U_{S})=1090.

Then, the function of the state value is given by:

$$f ( t ) = \frac{1090 {t}^{2}}{25000} {e}^{( \frac{{t}^{2}}{500} )}$$

This exemplary function is shown in FIG. 3. Considering that the target state in this example is defined as a state value above 6, the range of screen time values that will have a positive effect on the target state or during which the state value matches the target state is between 15 and 31 minutes, as denoted by the shaded area in FIG. 3.

In the next step, the system in this example restricts or recommends extending phone usage according to the retrieved screen time range. In the present example, the range of screen time values with a positive effect on the state value is between 15 and 31 minutes. By assuming that the context/situational parameter(s) and the purpose of use or mode of operation of the device remain constant, if the screen time of the user reaches a value above 31 minutes the device will restrict the screen usage for that purpose because further screen time in this mode of operation is predicted to result in the state value not matching the target state.

The device preferably does not only restrict screen time by offering the user a recommendation of an alternative mode of operation predicted to result in the state value matching the target state. Given the observed, retrieved or inferred values of the personal characteristics P_{S}, passive sensing data S_{S}, context C_{S} and current screen time t_{S}, and considering that the user has reached the upper limit of screen time usage that has a positive effect on the state value with the current mode of operation U_{S}, the device retrieves alternative modes of operation predicted within the current context to bring a positive effect to the state value, in particular to result in the state value matching the target state or tolerance range or to bring the state value closer to the target state.

In this case, the device computes the output of a (P_{S}, S_{S}, C_{S}, U) and b (P_{S}, S_{S}, C_{S}, U) for each different U while keeping the rest of the parameters constant. In our example, the outputs for given P_{S}, S_{S}, C_{S} as a function of U are:
a(U)=6+4purpose_{social media}+34purpose_{music}-purpose_{calls}+2purpose_{messaging}
b(U)=5000-3910purpose_{social media}+15660purpose_{music}-4677purpose_{calls}++4391purpose_{messaging}

Then, for each of the purposes/modes of operation the following screen time ranges are predicted to bring a positive effect to the state value for the following modes of operations, as illustrated in FIG. 4:
a(U=purpose_{social media})=10, b(U=purpose_{socialmedia})=1090, as a result the state value is predicted to match the target state for values of screen time between 15 and 30 minutes.
a(U=purpose_{music})=40, b(U=purpose_{music})=20660, as a result the state value is predicted to match the target state for values of screen time between 26 and 66 minutes.
a(U=purpose_{calls})=5, b(U=purpose_{calls})=323, as a result the state value is predicted to match the target state for values of screen time between 9 and 23 minutes.
a (U=purpose_{messaging})=8, b (U=purpose_{messaging})=609, as a result the state value is predicted to match the target state for values of screen time between 15 and 25 minutes.

In this example, if the user is using the device for social media and the screen time exceeds the 30 minutes, the device will recommend switching to using the device for playing music. This example thus illustrates a computer-implemented method for optimizing the operation of a device to achieve a desired target state, which includes the following steps:

monitoring a length of time during which a user interacts with the device, in particular a screen time by means of a monitoring unit;

acquiring by means of the monitoring unit data relating to a situational parameter of the user;

inferring by means of a model a context of the user based on the data relating to the situational parameter of the user;

determining based on the inferred context of the user a function linking the length of screen time to the achievement of a target state; and

based on the function linking the length of screen time to the achievement of a target state, restricting screen time, recommending to extend screen time and/or recommending to change the operation of the device from a first operational mode to a second operational mode.

The person skilled in the art will understand that when in this disclosure alternative wording is used to describe the same or similar subject-matter, the alternative terms or words may be used interchangeably or as synonyms. Additionally, the person skilled in the art will understand that if an element is disclosed in singular form with the article “a” or “an” this is not to be understood as “exactly one” but is meant in the sense of “at least one” with the disclosure not being limited to exactly one of these elements. Furthermore, it is apparent to the person skilled in the art that if certain elements or features of the invention have been disclosed in a certain combination or in the context of a certain embodiment or aspect, these elements or features of the invention may also be claimed in isolation or in different combinations or in the context of a different embodiment.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-16. (canceled)

17. A method comprising:
detecting a period of time during which a user interacts with a smartphone;
detecting a first operational mode in which the user interacts with the smartphone during the period of time;
identifying a first situational context in which the user is interacting with the smartphone;
determining an interaction benefit based on the period of time, the first operational mode and the situational context;
determining whether the interaction benefit equals or exceeds a target level; and
if the interaction benefit does not equal or exceed the target level, recommending that the user interacts with the smartphone in a second operational mode.

18. The method of claim 17, further comprising:
if the interaction benefit does not equal or exceed the target level, recommending that the user restricts an amount of time during which the user engages in the first operational mode.

19. The method of claim 17, further comprising:
if the interaction benefit does not equal or exceed the target level, suppressing notifications from the smartphone relating to the first operational mode.

20. The method of claim 17, wherein the target level corresponds to a condition selected from the group consisting of: a desired battery level and a desired device utilization level.

21. The method of claim 17, wherein the interaction benefit is determined as a function of the period of time, and wherein the first operational mode and the situational context are constant in the function.

22. The method of claim 21, further comprising:
determining, based on the function, a maximum amount of time during which the user can engage in the first operational mode and maintain the interaction benefit above or at the target level.

23. The method of claim 22, further comprising:
preventing the user from interacting with the smartphone in the first operational mode when the period of time during which the user has interacted with the smartphone exceeds the maximum amount of time.

24. The method of claim 17, wherein the interaction benefit is determined as a function of both the period of time during which the user interacts with the smartphone in the first operational mode and a second period of time during which the user interacts with the smartphone in the second operational mode, and wherein the situational context is constant in the function.

25. The method of claim 17, further comprising:
ranking a plurality of operational modes according to a maximum amount of time during which the user can engage in each operational mode and still maintain the interaction benefit above or at the target level; and
recommending that the user interacts with the smartphone in the second operational mode based on the second operational mode having a highest ranking.

26. The method of claim 17, wherein the interaction benefit is determined as of a first time instant, and wherein the period of time ends at the first time instant, further comprising:
determining a second interaction benefit as of a second time instant; and
indicating to the user whether the second interaction benefit is greater than, equal to, or less than the interaction benefit determined as of the first time instant.

27. The method of claim 17, wherein the situational context identifies a context selected from the group consisting of: a location of the user, an activity undertaken by the user, and a category of persons accompanying the user.

28. A system comprising:
a timer that detects a period of time during which a user of the system interacts with a smartphone;
a mode detector that identifies a first operational mode in which the user interacts with the smartphone during the period of time;
a sensor adapted to identify a situational context in which the user is interacting with the smartphone;
an evaluation unit adapted to determine an interaction benefit based on the period of time, the first operational mode and the situational context, wherein the evaluation unit determines whether the interaction benefit equals or exceeds a target level; and
a screen of the smartphone on which a recommendation is displayed to the user if the evaluation unit determines that the interaction benefit does not equal or exceed the target level.

29. The system of claim 28, wherein the recommendation is that the user should switch from interacting with the smartphone in the first operational mode to interacting with the smartphone in a second operational mode.

30. The system of claim 28, wherein the recommendation is that the user should limit an amount of time during which the user interacts with the smartphone in the first operational mode.

31. The system of claim 28, wherein the system suppresses notifications to the user from the first operational mode if the evaluation unit determines that the interaction benefit does not equal or exceed the target level.

32. The system of claim 28, wherein the evaluation unit determines the interaction benefit as a function of the period of time, and wherein the first operational mode and the situational context are constant in the function.

33. The system of claim 28, wherein the situational context identifies a context selected from the group consisting of: a location of the user, an activity undertaken by the user, and a category of persons accompanying the user.

34. A method comprising:
determining personal characteristics applicable to a user of a smartphone;
detect sensing data corresponding to how the user is interacting with the smartphone;
detecting a situational parameter corresponding to a context in which the user is interacting with the smartphone;
detecting an operational mode in which the user is interacting with the smartphone;
determining, based on the personal characteristics, the sensing data and the situational parameter, a maximum amount of time during which the user can interact with the smartphone in the operational mode and still maintain a target wellbeing level;
detecting a period of time during which the user is interacting with the smartphone in the operational mode; and
recommending that the user interacts with the smartphone in a second operational mode if the period of time exceeds the maximum amount of time.

35. The method of claim 34, wherein the personal characteristics are selected from the group consisting of: a gender of the user, an age of the user, an ethnicity of the user, and a personality score of the user.

36. The method of claim 34, wherein the sensing data are selected from the group consisting of: a step count sensed while the user is interacting with the smartphone in the operational mode, GPS coordinates of the smartphone while the user is interacting with the smartphone in the operational mode, total data consumption of the smartphone while the user is interacting with the smartphone in the operational mode, ambient light level while the user is interacting with the smartphone in the operational mode, and ambient noise level while the user is interacting with the smartphone in the operational mode.

37. The method of claim 34, wherein the context corresponding to the situational parameter is selected from the group consisting of: a location of the user, an activity undertaken by the user, a category of persons accompanying the user, and a time of day during which the user is interacting with the smartphone.

38. The method of claim 34, further comprising:
suppressing notifications from the smartphone relating to the operational mode if the period of time exceeds the maximum amount of time.

39. The method of claim 34, further comprising:
recommending that the user stops engaging in the operational mode if the period of time exceeds the maximum amount of time.

40-53. (canceled)
